(19) United States
(12) Patent Application Publication
(10) Pub. No.: US 2025/0389957 A1
(43) Pub. Date: Dec. 25, 2025

(54) IMAGE DISPLAY DEVICE

(71) Applicant: YAZAKI CORPORATION, Tokyo (JP)

(72) Inventor: Nobuyuki Takahashi, Susono-shi (JP)

(21) Appl. No.: 19/234,247

(22) Filed: Jun. 10, 2025

(30) Foreign Application Priority Data
Jun. 25, 2024 (JP) 2024-101987

(51) Int. Cl. G02B 27/01

(52) U.S. Cl. CPC G02B 27/0101; G02B 27/0149; G02B 2027/015

(57) ABSTRACT

An image display device includes a display unit that emits display light and a reflective optical unit that reflects the display light and projects the display light to a display member. The display unit includes a metal circuit board on which a light-emitting element is mounted by stacking a plate-shaped metal member in a thickness direction, and a display that receives light emitted from the light-emitting element and emits the display light. The metal circuit board has a disposition region where the light-emitting element is disposed and a non-disposition region where the light-emitting element is not disposed. The non-disposition region is provided at a position higher than the disposition region in a vertical direction.

### CROSS-REFERENCE TO RELATED APPLICATION(S)

The present application claims priority to and incorporates by reference the entire contents of Japanese Patent Application No. 2024-101987 filed in Japan on Jun. 25, 2024.

### BACKGROUND OF THE INVENTION

### 1. Field of the Invention

The present invention relates to an image display device.

### 2. Description of the Related Art

In the related art, as an image display device, for example, as disclosed in Japanese Patent Application Laid-open No. 2011-165624, an image display device including a display (display), a plurality of light sources illuminating the display device, and a circuit board on which a plurality of light sources is mounted is known. In this image display device, to dissipate heat, a heat dissipator in which a plurality of heat dissipation plates are formed is attached to the circuit board.

The above-described image display device disclosed in Japanese Patent Application Laid-open No. 2011-165624 requires a space for installing the heat dissipator, and there is room for improvement in that downsizing of the device is difficult.

### SUMMARY OF THE INVENTION

Therefore, an object of the present invention is to provide an image display device capable of efficiently dissipating heat and miniaturizing the device.

An image display device according to one aspect of the present invention includes a display unit configured to emit display light; and a reflective optical unit configured to reflect the display light and project the display light to a display member, wherein the display unit includes a metal circuit board on which a light-emitting element is mounted by stacking a plate-shaped metal member in a thickness direction, and a display that receives light emitted from the light-emitting element and emits the display light, the metal circuit board has a disposition region where the light-emitting element is disposed and a non-disposition region where the light-emitting element is not disposed, and the non-disposition region is provided at a position higher than the disposition region in a vertical direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a schematic configuration of an image display device according to an embodiment;

FIG. 2 is a perspective view illustrating a display unit of the image display device according to the embodiment;

FIG. 3 is an exploded perspective view illustrating the display unit of the image display device according to the embodiment;

FIG. 4 is a perspective view illustrating an overview of a metal circuit board of the image display device according to the embodiment; and

FIG. 5 is a side view illustrating a metal circuit board of the image display device according to the embodiment.

### DETAILED DESCRIPTION OF THE PREFERRED EMBODIMENTS

Hereinafter, an embodiment according to the present invention will be described in detail with reference to the drawings. The present invention is not limited by the embodiment. Constituents in the following embodiments include those that can be easily replaced by those skilled in the art or those that are substantially the same.

### EMBODIMENT

The embodiment relates to an image display device. In the following description, of first, second, and third directions intersecting each other, the first direction is referred to as a “front-rear direction X”, the second direction is referred to as a “vehicle width direction Y”, and the third direction is referred to as a “height direction Z”. Here, the front-rear direction X, the vehicle width direction Y, and the height direction Z are orthogonal to each other. The front-rear direction X corresponds to the front-rear direction of a vehicle on which the image display device is mounted. The vehicle width direction Y corresponds to the vehicle width direction of the vehicle on which the image display device is mounted. The vehicle width direction Y and the height direction Z correspond to intersecting directions intersecting the front-rear direction X. Each direction used in the following description represents a direction in a state where each unit is mounted on a vehicle unless otherwise specified. The term “orthogonal” as used herein includes substantially orthogonal.

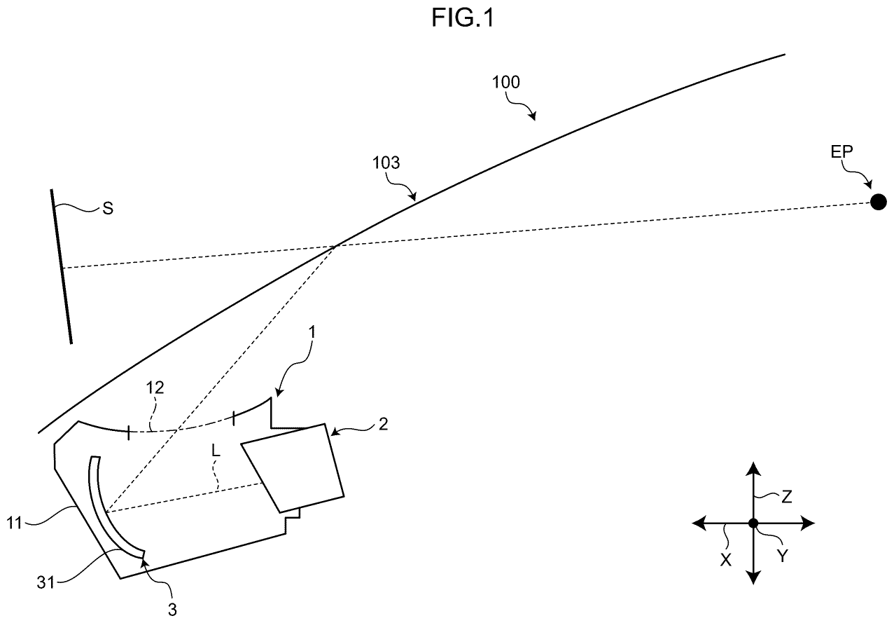

As illustrated in FIG. 1, an image display device 1 is a device that is installed in a vehicle 100 and displays an image. For example, the image display device 1 is a head-up display device that projects display light L to a display member 103 of the vehicle 100 to display a virtual image S. In the vehicle 100, the image display device 1 projects the display light L to the display member 103 and causes a driver of the vehicle 100 to recognize the virtual image S in front of an eye point EP. The display member 103 is, for example, a windshield. The image display device 1 is disposed below the display member 103 and is installed, for example, inside an instrument panel provided on a dashboard. The eye point EP is assumed in advance as a viewpoint position of the driver.

The image display device 1 includes a display unit 2 and a reflective optical unit 3. The display unit 2 and the reflective optical unit 3 are housed or installed in a housing 11 and emit the display light L from an opening 12 to the display member 103.

The reflective optical unit 3 is an optical system unit that reflects the display light L and guides the display light L toward the display member 103, and is configured by, for example, a mirror 31. The mirror 31 reflects the display light L emitted from the display unit 2 and projects the display light L to the display member 103 through the opening 12. The mirror 31 has, for example, a concave reflection surface and can enlarge an image. The shape of the reflection surface is, for example, a free-form surface, and can be a shape capable of correcting image distortion and aberration. Although FIG. 1 illustrates a case where the reflective optical unit 3 is configured by one mirror 31, the reflective optical unit 3 may be configured by a plurality of mirrors and reflect the display light L a plurality of times.

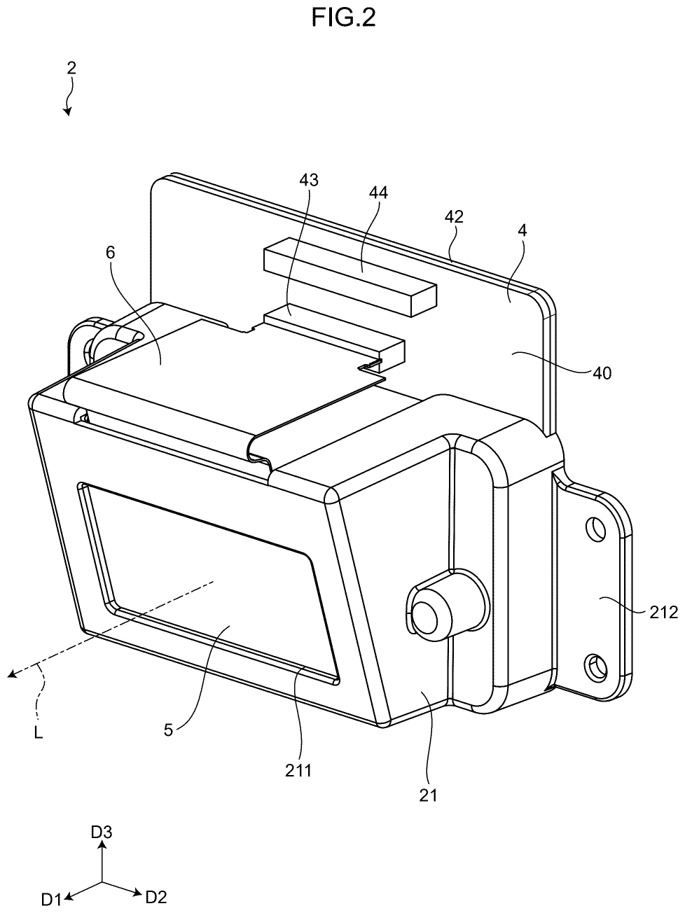

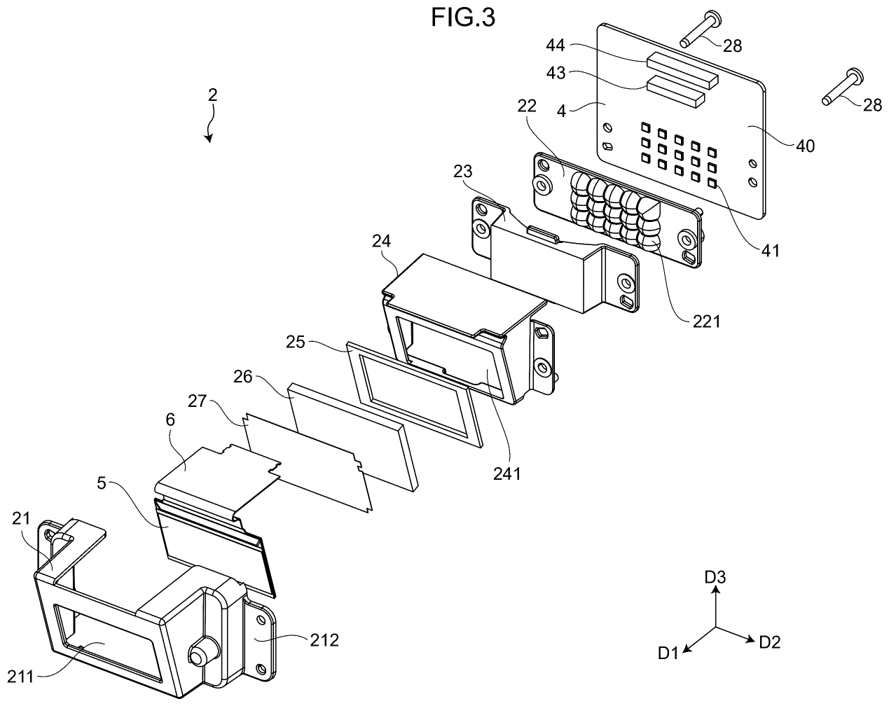

As illustrated in FIGS. 2 and 3, the display unit 2 is a unit that generates and outputs the display light L, and includes a metal circuit board 4, a display 5, and a wiring member 6. For example, the display unit 2 is configured by attaching a cover 21 to the metal circuit board 4 and is configured by sequentially disposing a condenser lens 22, a light distribution lens 23, a case 24, a frame member 25, a sheet material 26, a sheet material 27, and the display 5 between the metal circuit board 4 and the cover 21. In the drawing, a depth direction of the display unit 2 is referred to as a “unit front-rear direction D1”, a width direction is referred to as a “unit width direction D2”, and a height direction is referred to as a “unit height direction D3”. The unit front-rear direction D1, the unit width direction D2, and the unit height direction D3 are orthogonal to each other. The unit front-rear direction D1 is typically a direction oriented along an emission direction of the display light L or a direction oriented along the thickness direction of the metal circuit board 4, and is a direction diagonally intersecting the front-rear direction X illustrated in FIG. 1 in an installation state on the vehicle 100. The unit width direction D2 is typically a direction oriented along the vehicle width direction Y illustrated in FIG. 1.

The metal circuit board 4 is a circuit board on which the light-emitting element 41 is mounted, and is a component included in a backlight. For example, the metal circuit board 4 has a plate-shaped metal member 42, and the light-emitting element 41 is mounted on the metal member 42 via an insulating layer. The metal member 42 is provided to be stacked in the thickness direction of the metal circuit board 4 and is formed to have the same size as a main surface 40 of the metal circuit board 4. The same size here includes substantially the same size. As the metal member 42, for example, a plate material containing aluminum as a main component is used. An aluminum plate material, an aluminum alloy plate material, or the like corresponds to the plate material containing aluminum as a main component.

The main surface 40 of the metal circuit board 4 is a surface of the plate-shaped metal circuit board 4 and is a surface formed in a direction intersecting the thickness direction. The thickness direction is a direction oriented along the unit front-rear direction D1. The light-emitting elements 41 are light sources that emit light to serve as a backlight, and a plurality of the light-emitting elements are arrayed and provided on the main surface 40 of the metal circuit board 4. As the light-emitting element 41, for example, a light emitting diode (LED) is used. The light-emitting element 41 is surface-mounted using, for example, a chip component. The light-emitting element 41 may be a component that has a lead wire and is inserted and mounted or may be a light emitting component other than the LED.

The cover 21 is a box-shaped component of which a surface facing the metal circuit board 4 is opened and, for example, is attached to the main surface 40 of the metal circuit board 4 and fixed with a screw 28. An emission window 211 is formed in the cover 21 so that the display light L can be emitted. The cover 21 has flange portions 212 formed at both ends in the unit width direction D2 and can be fixed to the housing 11, a member attached to the housing 11, or the like.

The condenser lens 22 is a lens that condenses light emitted from the light-emitting element 41 and is formed by a light-transmitting member. The condenser lens 22 includes a plurality of lens units 221 corresponding to the plurality of light-emitting elements 41, and condenses light emitted from each light-emitting element 41 by each lens unit 221. The lens unit 221 has a flat incidence surface and a protruding emission surface and is formed to face the light-emitting element 41. By providing the lens unit 221 for each of the plurality of light-emitting elements 41 in this manner, a light distribution angle or an irradiation angle of the light emitted from the light-emitting element 41 can be set small, and a distance between the condenser lens 22 and the light distribution lens 23 can be shortened. Therefore, in the image display device 1 according to the embodiment, the backlight unit including the light-emitting elements 41, the condenser lens 22, and the light distribution lens 23 can be made thin.

The light distribution lens 23 is a lens that adjusts a traveling direction of light emitted from the condenser lens 22 in a predetermined direction, and includes a light-transmitting member. The light distribution lens 23 is disposed to face the condenser lens 22.

The case 24 is provided to cover the condenser lens 22 and the light distribution lens 23 with the metal circuit board 4. For example, the case 24 is integrated with the metal circuit board 4, the condenser lens 22, the light distribution lens 23, and the cover 21 with screws 28. In other words, the screw 28 sequentially passes through the metal circuit board 4, the condenser lens 22, the light distribution lens 23, and the case 24 to be screwed into the cover 21. An opening 241 is formed in the case 24, and light emitted from the light distribution lens 23 can be guided in the unit front-rear direction D1.

The frame member 25, a sheet material 26, a sheet material 27, and the display 5 are provided between the case 24 and the cover 21. The sheet material 26 and the sheet material 27 are optical sheets. For example, diffusion sheets, condensing sheets, or the like are used.

The display 5 is disposed to face the light-emitting elements 41 and emits the display light L. The display 5 is a device that emits the display light L by transmitting the optically processed light emitted from the light-emitting elements 41. For example, a light transmissive TFT liquid crystal display (thin film transistor Liquid crystal display) is used as the display 5.

The wiring member 6 is connected to the display 5. The wiring member 6 is a wiring member for controlling the display 5, and electrically connects the display 5 to the metal circuit board 4. The wiring member 6 is configured by a planar circuit board. For example, a flexible printed circuit board is used. The wiring member 6 extends from a connection position with the display 5 to the outside of the cover 21 in the unit front-rear direction D1 and is connected to the metal circuit board 4. That is, the wiring member 6 is connected to a connector 43 mounted on the metal circuit board 4.

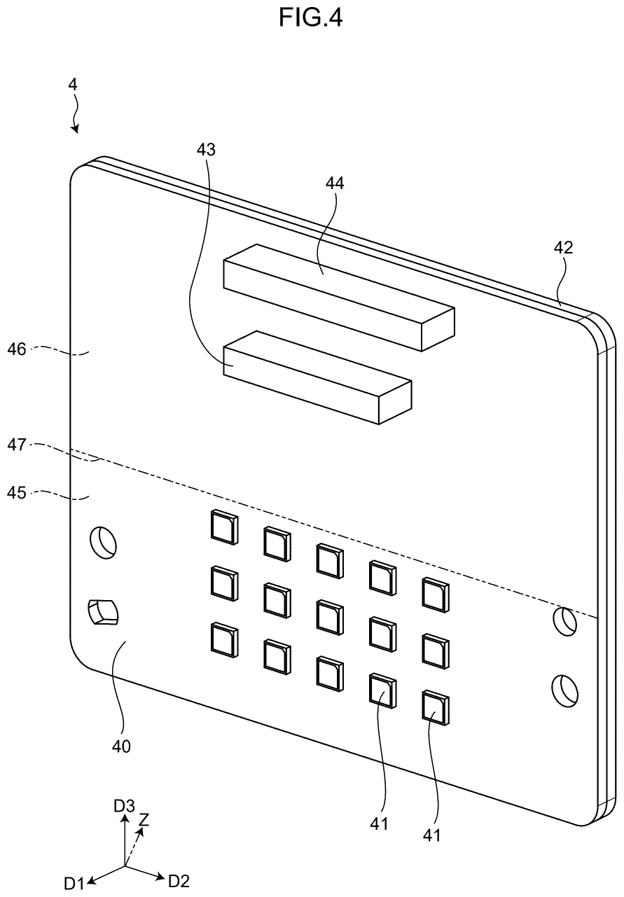

As illustrated in FIG. 4, the metal circuit board 4 is formed in a rectangular plate shape, and the light-emitting element 41 is mounted on the main surface 40. The plurality of light-emitting elements 41 are mounted and arrayed in the unit width direction D2 and the unit height direction D3. For example, five light-emitting elements 41 are disposed in the unit width direction D2, three light-emitting elements are disposed in the unit height direction D3, and a total of fifteen light-emitting elements are disposed. The number and array of the light-emitting elements 41 are not limited to those illustrated in FIG. 4.

The metal circuit board 4 has a disposition region 45 and a non-disposition region 46. The non-disposition region 46 is provided at a position higher than the disposition region 45 in the vertical direction in the metal circuit board 4. In FIG. 4, the vertical direction is a direction oriented along the height direction Z and is a direction inclined with respect to the unit height direction D3. The metal circuit board 4 is provided in a direction intersecting the horizontal direction. That is, the metal circuit board 4 is provided so that the normal direction of the main surface 40 intersects the vertical direction. The normal direction of the main surface 40 is the unit front-rear direction D1, and the vertical direction is the height direction Z. When the metal circuit board 4 is not disposed so that the normal direction of the main surface 40 is the vertical direction, the non-disposition region 46 can be provided at a position higher than the disposition region 45. That is, when the metal circuit board 4 is disposed so that the main surface 40 is orthogonal to the vertical direction, the non-disposition region 46 and the disposition region 45 are located at the same height in the vertical direction. However, when the metal circuit board 4 is disposed so that the main surface 40 is not orthogonal to the vertical direction, the non-disposition region 46 can be provided at a position higher than the disposition region 45.

The disposition region 45 is a region where the light-emitting element 41 is disposed on the main surface 40 of the metal circuit board 4. The non-disposition region 46 is a region other than the disposition region 45 on the main surface 40 of the metal circuit board 4. For example, the disposition region 45 is a region below the upper end position 47 of the light-emitting element 41 disposed at the uppermost portion with respect to the unit height direction D3 on the main surface 40 of the metal circuit board 4. The non-disposition region 46 is a region above the upper end position 47 on the main surface 40 of the metal circuit board 4. That is, in the metal circuit board 4, the light-emitting elements 41 are mounted while being biased to a lower position. For example, the non-disposition region 46 is set to be larger than the disposition region 45.

The connector 43 connected to the wiring member 6 is mounted on the metal circuit board 4 together with the light-emitting element 41. Since the connector 43 is not a component that generates heat, for example, it is also conceivable to mount the connector 43 on a circuit board that does not include the metal member 42. However, in the image display device 1 according to the embodiment, the metal circuit board 4 can be formed largely by mounting the connector 43 on the metal circuit board 4. The connector 43 is installed, for example, in the non-disposition region 46 of the metal circuit board 4.

The connector 43 is mounted on the metal circuit board 4 at a position higher than the light-emitting element 41 in the vertical direction. For example, the connector 43 is provided in the non-disposition region 46 of the metal circuit board 4 and is mounted at a position higher than the light-emitting element 41 provided in the disposition region 45. Therefore, heat H generated from the light-emitting element 41 efficiently moves toward the connector 43.

The light emission control connector 44 is mounted on the metal circuit board 4. The light emission control connector 44 is a connector connecting a wiring member (not illustrated) for light emission control of the light-emitting element 41. The wiring member for light emission control is connected to, for example, a device outside of the image display device 1. In FIG. 4, the connector 43 and the light emission control connector 44 are schematically configured.

Next, a heat dissipation function of the image display device 1 according to the embodiment will be described.

In FIG. 2, when the image display device 1 is operated, a control signal is input to the display 5 through the wiring member 6, and the display 5 generates an image according to the control signal. In FIG. 3, the operation signal is input to the light-emitting element 41, and the light-emitting element 41 emits light. The light emitted from the light-emitting element 41 is optically processed by the condenser lens 22, the light distribution lens 23, the sheet material 26, and the sheet material 27, and is incident on the display 5.

Then, in FIG. 1, the display light L is output from the display 5. The display light L is reflected by the reflective optical unit 3, is emitted from the opening 12, and is projected to the display member 103. The driver of the vehicle 100 can recognize the display light L projected to the display member 103 as the virtual image S.

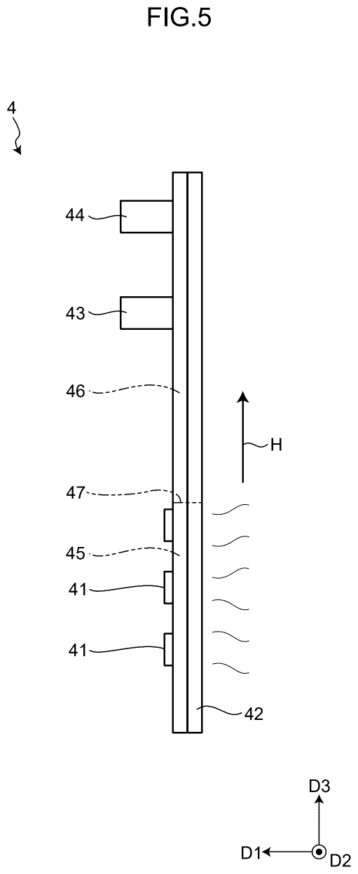

In FIG. 5, with the operation of the image display device 1, the light-emitting elements 41 mounted on the metal circuit board 4 emit light and generate heat. The heat generated from the light-emitting elements 41 is conducted to the metal member 42 and is dissipated through the metal member 42. Here, the metal member 42 is stacked in the thickness direction (unit front-rear direction D1) in the metal circuit board 4, and is provided to be connected from the disposition region 45 where the light-emitting elements 41 are mounted to the non-disposition region 46 where the connector 43 is mounted. Therefore, the heat H generated from the light-emitting element 41 moves in the unit width direction D2 and the unit height direction D3 through the metal member 42, is conducted to the connector 43 side, and is diffused in a wide range. That is, the heat H is conducted from the disposition region 45 to the non-disposition region 46 and is dissipated in a range of the disposition region 45 and the non-disposition region 46. Accordingly, in the image display device 1 according to the embodiment, heat dissipation efficiency is higher in the metal circuit board 4 than in a case of dissipation of heat only in the disposition region 45. Accordingly, in the image display device 1 according to the embodiment, since a predetermined heat dissipation effect can be obtained without installing a plurality of heat dissipation fins or the like in the metal member 42, components included in the backlight can be made thin, which can miniaturize the display unit 2 and the image display device 1.

As illustrated in FIG. 5, in the metal circuit board 4, the non-disposition region 46 is provided at a position higher than the disposition region 45. Therefore, the heat H generated by the light-emitting element 41 smoothly moves from the disposition region 45 to the non-disposition region 46 through the metal member 42 to be diffused. Accordingly, in the image display device 1 according to the embodiment, the heat H generated from the light-emitting element 41 can be efficiently dispersed by the metal circuit board 4, which can enhance the heat dissipation. Accordingly, in the image display device 1 according to the embodiment, sufficient heat dissipation can be performed even when the installation of the heat dissipation fin on the metal circuit board 4 is omitted, the components included in the backlight can be made thin, which can miniaturize the display unit 2 and the image display device 1.

As described above, in the image display device 1 according to the embodiment, the non-disposition region 46 is provided at a position higher than the disposition region 45 in the metal circuit board 4, and thus the heat generated by the light-emitting element 41 can be smoothly moved from the disposition region 45 to the non-disposition region 46 through the metal member 42 to be diffused. Therefore, in the image display device 1 according to the embodiment, it is possible to enhance heat dissipation by the metal circuit board 4. Accordingly, in the image display device 1 according to the embodiment, it is possible to omit installation of heat dissipation fins or the like to achieve the miniaturization.

In the image display device 1 according to the embodiment, by providing the metal circuit board 4 in a direction intersecting the horizontal direction, the non-disposition region 46 can be provided at a position higher than the disposition region 45. Therefore, in the image display device 1 according to the embodiment, it is possible to enhance heat dissipation by the metal circuit board 4.

In the image display device 1 according to the embodiment, by mounting the light-emitting elements 41 and the connector 43 on the metal circuit board 4, the metal circuit board 4 can be formed larger than in a case where a relay board for mounting the connector 43 is installed separately from the metal circuit board 4, which can enhance heat dissipation by the metal circuit board 4. Therefore, the image display device 1 according to the embodiment can be miniaturized by omitting installation of heat dissipation fins or the like.

In the image display device 1 according to the embodiment, the connector 43 is mounted on the metal circuit board 4 at a position higher than the light-emitting element 41 in the vertical direction, so that the heat H generated from the light-emitting element 41 can be efficiently moved to the connector 43 side, which can enhance the heat dissipation by the metal circuit board 4.

Although the image display device according to the embodiment has been described, the image display device according to the present invention is not limited to the above-described embodiment, and various modifications can be made within the scope described in the claims. The image display device according to the embodiment may be configured by appropriately combining components of the embodiments and modifications described above.

In the image display device according to the present embodiment, it is possible to efficiently dissipate heat and miniaturize the device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image display device comprising:
a display unit configured to emit display light; and
a reflective optical unit configured to reflect the display light and project the display light to a display member, wherein
the display unit includes a metal circuit board on which a light-emitting element is mounted by stacking a plate-shaped metal member in a thickness direction, and a display that receives light emitted from the light-emitting element and emits the display light,
the metal circuit board has a disposition region where the light-emitting element is disposed and a non-disposition region where the light-emitting element is not disposed, and
the non-disposition region is provided at a position higher than the disposition region in a vertical direction.

2. The image display device according to claim 1, wherein
the metal circuit board is provided in a direction intersecting a horizontal direction.
